(19) United States
(12) Patent Application Publication
(10) Pub. No.: US 2014/0244737 A1
(43) Pub. Date: Aug. 28, 2014

(54) METHODS, APPARATUSES, AND COMPUTER PROGRAM PRODUCTS FOR ENHANCING A COMMUNICATION SESSION

(71) Applicant: NOKIA CORPORATION, Espoo (FI)

(72) Inventors: Bryan Thomas Biniak, Pacific Palisades, CA (US); Don Yamato Kuramura, Redondo Beach, CA (US)

(73) Assignee: NOKIA CORPORATION, Espoo (FI)

(21) Appl. No.: 13/774,287

(22) Filed: Feb. 22, 2013

(51) Int. Cl. H04L 29/08

(52) U.S. Cl. CPC H04L 67/104
USPC 709/204

(57) ABSTRACT

Methods, apparatuses, and computer program products are herein provided for providing trivia during a communication session. A method may include determining at least one trivia candidate for a communication session between at least two users. The at least one trivia candidate comprises factual information relevant to a context of the communication session. The method may further include causing the at least one trivia candidate to be proposed to at least one of the users. Corresponding apparatuses and computer program products are also provided.

### TECHNOLOGICAL FIELD

An example embodiment of the present invention relates generally to user interface technology and, more particularly, relates to methods, apparatuses, and computer program products for enhancing a communication session.

### BACKGROUND

The modern communications era has brought about a tremendous expansion of wireline and wireless networks. Wireless and mobile networking technologies have addressed related consumer demands, while providing more flexibility and immediacy of information transfer. Concurrent with the expansion of networking technologies, an expansion in computing power has resulted in development of affordable computing devices capable of taking advantage of services made possible by modern networking technologies. This expansion in computing power has led to a reduction in the size of computing devices and given rise to a new generation of mobile devices that are capable of performing functionality that only a few years ago required processing power that could be provided only by the most advanced desktop computers. Consequently, mobile computing devices having a small form factor have become ubiquitous and are used to access network applications and services by consumers of all socioeconomic backgrounds.

With increased functionality, mobile computing devices can be used to perform a variety of functions, including enabling communication between two or more users. In such a manner, even though users are remotely located from each other, they can engage in a communication session to stay in contact.

### BRIEF SUMMARY

During a communication session, two or more users may engage in conversation or share an experience. Some example embodiments of the present invention seek to enhance that experience by proposing trivia that may be relevant to the communication session. Indeed, the trivia can be proposed to one or more of the users to be utilized during the communication session. Such trivia may include factual information that is relevant to a context of the communication session. The factual information may be based on information from any number of different sources, such as internet searches of keywords used in the communication session or interesting information taken from social networking websites.

In one example embodiment, a method includes determining at least one trivia candidate for a communication session between at least two users. The at least one trivia candidate comprises factual information relevant to a context of the communication session. The method further includes causing the at least one trivia candidate to be proposed to at least one of the users.

In some embodiments, the method further includes determining the at least one trivia candidate by determining the at least one trivia candidate based on at least one keyword associated with the communication session. Additionally, in some embodiments, the at least one keyword has been previously used by at least one of the users in the communication session.

In some embodiments, the method further includes determining the at least one trivia candidate by determining the at least one trivia candidate based on information from a social networking website. In some embodiments, the method further includes determining the at least one trivia candidate by determining the at least one trivia candidate based on information from a network search.

In some embodiments, the method further includes causing the at least one trivia candidate to be proposed to at least one of the users by causing the at least one trivia candidate to be proposed such that the at least one trivia candidate is able to be utilized during the communication session.

In some embodiments, the method further includes receiving an indication of a selection of the at least one trivia candidate by at least one user of the communication session. Additionally, the method may include causing the at least one trivia candidate to be presented to at least one other user of the communication session in response to receiving the indication of the selection of the at least one trivia candidate. Additionally, in some embodiments, the communication session comprises a text-based communication session.

In some embodiments, the method further includes causing the at least one trivia candidate to be proposed to at least one of the users by causing the at least one trivia candidate to be presented to the at least one user. Additionally, in some embodiments, the communication session comprises a voice-based communication session.

In another example embodiment, an apparatus comprises at least one processor and at least one memory storing computer program code with the at least one memory and stored computer program code being configured, with the at least one processor, to cause the apparatus to determine at least one trivia candidate for a communication session between at least two users. The at least one trivia candidate comprises factual information relevant to a context of the communication session. The at least one memory and stored computer program code are configured, with the at least one processor, to further cause the apparatus to cause the at least one trivia candidate to be proposed to at least one of the users.

In another example embodiment, a computer program product is provided. The computer program product of this example embodiment includes at least one computer-readable storage medium having computer-readable program instructions stored therein. The program instructions of this example embodiment comprise program instructions configured to cause an apparatus to perform a method including determining at least one trivia candidate for a communication session between at least two users. The at least one trivia candidate comprises factual information relevant to a context of the communication session. The method further includes causing the at least one trivia candidate to be proposed to at least one of the users.

In another example embodiment, an apparatus is provided. The apparatus comprises means for determining at least one trivia candidate for a communication session between at least two users. The at least one trivia candidate comprises factual information relevant to a context of the communication session. The apparatus further comprises means for causing the at least one trivia candidate to be proposed to at least one of the users.

### BRIEF DESCRIPTION OF THE DRAWINGS

Having thus described some embodiments of the invention in general terms, reference will now be made to the accompanying drawings, which are not necessarily drawn to scale, and wherein:

FIG. 1 illustrates a block diagram of an apparatus according to an example embodiment of the present invention;

FIG. 2 is a schematic block diagram of a mobile terminal according to an example embodiment of the present invention;

FIG. 3 illustrates an example communication session between two different apparatuses through a network, such apparatuses may embody, for example, the apparatus shown in FIG. 1, in accordance with an example embodiment of the present invention described herein;

FIG. 4 illustrates an example communication session on an apparatus, such as the apparatus shown in FIG. 1, wherein the users of the communication session are watching a video and engaged in a text-based communication session, in accordance with an example embodiment of the present invention described herein;

FIG. 5 illustrates the apparatus shown in FIG. 4, wherein the apparatus is performing a search over a network for forming one or more trivia candidates, in accordance with an example embodiment of the present invention described herein;

FIG. 6 illustrates the apparatus shown in FIG. 4, wherein trivia candidates have been proposed to the user, in accordance with an example embodiment of the present invention described herein;

FIG. 6A illustrates another example communication session on an apparatus, such as the apparatus shown in FIG. 1, wherein trivia candidates have been proposed to the user on a second apparatus, in accordance with an example embodiment of the present invention described herein;

FIG. 6B illustrates another example communication session on a TV, wherein trivia candidates have been proposed to the user on an apparatus, such as the apparatus shown in FIG. 1, in accordance with an example embodiment of the present invention described herein;

FIG. 7 illustrates the apparatus shown in FIG. 4, wherein the user has selected a trivia candidate, and in response, the trivia candidate has been presented within the communication session, in accordance with an example embodiment of the present invention described herein;

FIG. 8 illustrates a flowchart according to an example method for proposing trivia during a communication session, in accordance with an example embodiment of the present invention described herein; and

FIG. 9 illustrates a flowchart according to another example method for proposing trivia during a communication session, in accordance with an example embodiment of the present invention described herein.

### DETAILED DESCRIPTION

Some example embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout.

As used herein, the terms “data,” “content,” “information” and similar terms may be used interchangeably to refer to singular or plural data capable of being transmitted, received, displayed and/or stored in accordance with various example embodiments. Thus, use of any such terms should not be taken to limit the spirit and scope of the disclosure.

The term “computer-readable medium” as used herein refers to any medium configured to participate in providing information to a processor, including instructions for execution. Such a medium may take many forms, including, but not limited to a non-transitory computer-readable storage medium (e.g., non-volatile media, volatile media), and transmission media. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Examples of non-transitory computer-readable media include a magnetic computer readable medium (e.g., a floppy disk, hard disk, magnetic tape, any other magnetic medium), an optical computer readable medium (e.g., a compact disc read only memory (CD-ROM), a digital versatile disc (DVD), a Blu-Ray disc, or the like), a random access memory (RAM), a programmable read only memory (PROM), an erasable programmable read only memory (EPROM), a FLASH-EPROM, or any other non-transitory medium from which a computer can read. The term computer-readable storage medium is used herein to refer to any computer-readable medium except transmission media. However, it will be appreciated that where embodiments are described to use a computer-readable storage medium, other types of computer-readable mediums may be substituted for or used in addition to the computer-readable storage medium in alternative embodiments.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

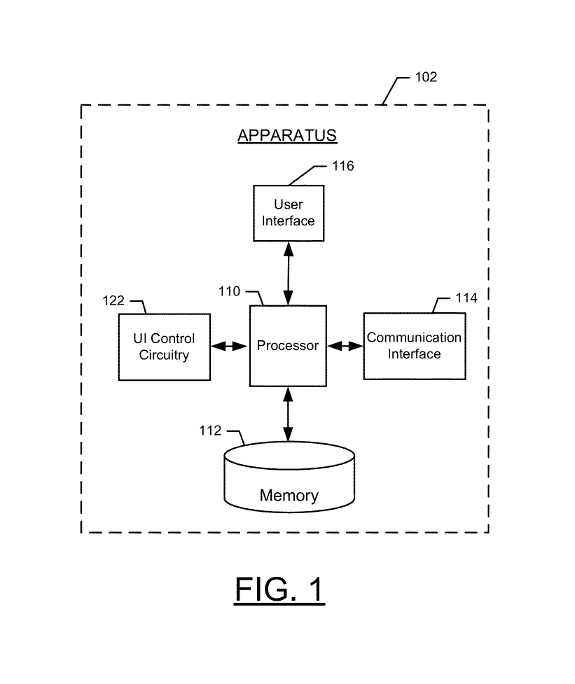

FIG. 1 illustrates a block diagram of an apparatus 102 configured for proposing trivia during a communication session according to an example embodiment. It will be appreciated that the apparatus 102 is provided as an example of one embodiment and should not be construed to narrow the scope or spirit of the invention in any way. In this regard, the scope of the disclosure encompasses many potential embodiments in addition to those illustrated and described herein. As such, while FIG. 1 illustrates one example of a configuration of an apparatus for performing operations and operational routing, other configurations may also be used to implement embodiments of the present invention.

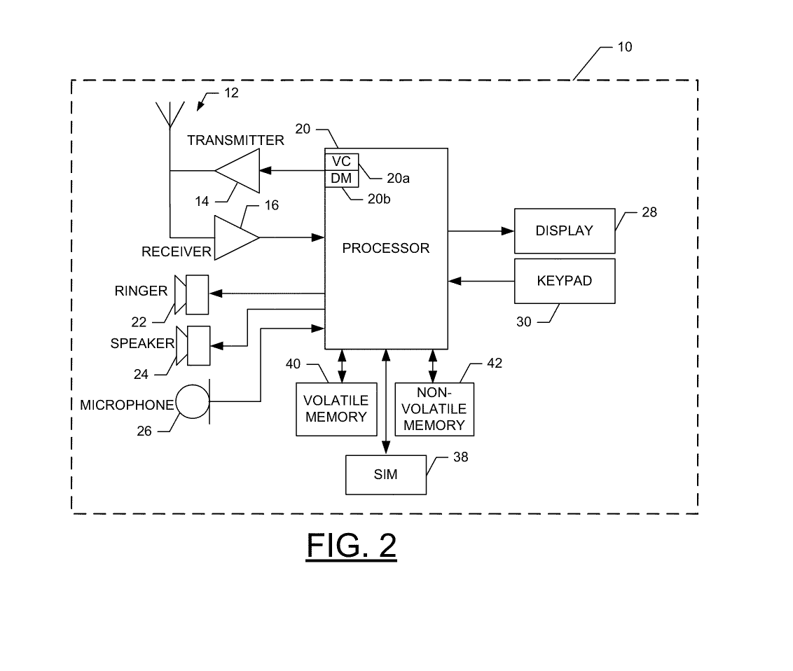

The apparatus 102 may be embodied as either a fixed device or a mobile device such as a desktop computer, laptop computer, mobile terminal, mobile computer, mobile phone, mobile communication device, game device, digital camera/camcorder, audio/video player, television device, radio receiver, digital video recorder, positioning device, a chipset, a computing device comprising a chipset, any combination thereof, and/or the like. In this regard, the apparatus 102 may comprise any computing device that comprises or is in operative communication with a user interface (e.g., a touch display capable of displaying a graphical user interface). In some example embodiments, the apparatus 102 is embodied as a mobile computing device, such as the mobile terminal illustrated in FIG. 2.

In this regard, FIG. 2 illustrates a block diagram of a mobile terminal 10 representative of one example embodiment of an apparatus 102. It should be understood, however, that the mobile terminal 10 illustrated and hereinafter described is merely illustrative of one type of apparatus 102 that may implement and/or benefit from various example embodiments of the invention and, therefore, should not be taken to limit the scope of the disclosure. While several embodiments of the apparatus are illustrated and will be hereinafter described for purposes of example, other types of apparatuses, such as mobile telephones, mobile computers, personal digital assistants (PDAs), pagers, laptop computers, desktop computers, gaming devices, positioning devices, tablet computers, televisions, e-papers, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some embodiments the processor 20 comprises a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various first generation (1G), second generation (2G), 2.5G, third-generation (3G) communication protocols, fourth-generation (4G) communication protocols, Internet Protocol Multimedia Subsystem (IMS) communication protocols (e.g., session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as Long Term Evolution (LTE) or Evolved Universal Terrestrial Radio Access Network (E-UTRAN) and/or the like. Additionally, for example, the mobile terminal may be capable of operating in accordance with fourth-generation (4G) wireless communication protocols and/or the like as well as similar wireless communication protocols that may be developed in the future.

Some Narrow-band Advanced Mobile Phone System (NAMPS), as well as Total Access Communication System (TACS), mobile terminals may also benefit from embodiments of this invention, as should dual or higher mode phones (e.g., digital/analog or TDMA/CDMA/analog phones). Additionally, the mobile terminal 10 may be capable of communicating according to Wi-Fi, Near Field Communications (NFC), BlueTooth, Worldwide Interoperability for Microwave Access (WiMAX) or other proximity-based communications protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. The processor may additionally comprise an internal voice coder (VC) 20a, an internal data modem (DM) 20b, and/or the like. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using a Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (e.g., software and/or firmware) stored on a memory accessible to the processor 20 (e.g., volatile memory 40, non-volatile memory 42, and/or the like). Although not shown, the mobile terminal may comprise a battery for powering various circuits related to the mobile terminal, for example, a circuit to provide mechanical vibration as a detectable output. The display 28 of the mobile terminal may be of any type appropriate for the electronic device in question with some examples including a plasma display panel (PDP), a liquid crystal display (LCD), a light-emitting diode (LED), an organic light-emitting diode display (OLED), a projector, a holographic display or the like. The display 28 may, for example, comprise a three-dimensional touch display, examples of which will be described further herein below. The user input interface may comprise devices allowing the mobile terminal to receive data, such as a keypad 30, a touch display (e.g., some example embodiments wherein the display 28 is configured as a touch display), a joystick (not shown), and/or other input device. In embodiments including a keypad, the keypad may comprise numeric (0-9) and related keys (#, *), and/or other keys for operating the mobile terminal 10. Alternatively or additionally, the keypad 30 may include a conventional QWERTY keypad arrangement.

The mobile terminal 10 may comprise memory, such as a subscriber identity module (SIM) 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (e.g., hard disks, floppy disk drives, magnetic tape, etc.), optical disc drives and/or media, non-volatile random access memory (NVRAM), and/or the like. Like volatile memory 40 non-volatile memory 42 may include a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

Returning to FIG. 1, in an example embodiment, the apparatus 102 includes various means for performing the various functions herein described. These means may comprise one or more of a processor 110, memory 112, communication interface 114, user interface 116, or user interface (UI) control circuitry 122. The means of the apparatus 102 as described herein may be embodied as, for example, circuitry, hardware elements (e.g., a suitably programmed processor, combinational logic circuit, and/or the like), a computer program product comprising computer-readable program instructions (e.g., software or firmware) stored on a computer-readable medium (e.g. memory 112) that is executable by a suitably configured processing device (e.g., the processor 110), or some combination thereof.

In some example embodiments, one or more of the means illustrated in FIG. 1 may be embodied as a chip or chip set. In other words, the apparatus 102 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. In this regard, the processor 110, memory 112, communication interface 114, and/or UI control circuitry 122 may be embodied as a chip or chip set. The apparatus 102 may therefore, in some cases, be configured to or may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC or FPGA, one or more other types of hardware processors, or some combination thereof. Accordingly, although illustrated in FIG. 1 as a single processor, in some embodiments the processor 110 comprises a plurality of processors. The plurality of processors may be in operative communication with each other and may be collectively configured to perform one or more functionalities of the apparatus 102 as described herein. The plurality of processors may be embodied on a single computing device or distributed across a plurality of computing devices collectively configured to function as the apparatus 102. In embodiments wherein the apparatus 102 is embodied as a mobile terminal 10, the processor 110 may be embodied as or comprise the processor 20 (shown in FIG. 2). In some example embodiments, the processor 110 is configured to execute instructions stored in the memory 112 or otherwise accessible to the processor 110. These instructions, when executed by the processor 110, may cause the apparatus 102 to perform one or more of the functionalities of the apparatus 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise a non-transitory computer-readable storage medium. Although illustrated in FIG. 1 as a single memory, the memory 112 may comprise a plurality of memories. The plurality of memories may be embodied on a single computing device or may be distributed across a plurality of computing devices collectively configured to function as the apparatus 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the apparatus 102 is embodied as a mobile terminal 10, the memory 112 may comprise the volatile memory 40 and/or the non-volatile memory 42 (shown in FIG. 2). The memory 112 may be configured to store information, data, applications, instructions, or the like for enabling the apparatus 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. The stored information may include, for example, images, content, media content, user data, application data, and/or the like. This stored information may be stored and/or used by the UI control circuitry 122 during the course of performing its functionalities.

The communication interface 114 may be embodied as any device or means embodied in circuitry, hardware, a computer program product comprising computer readable program instructions stored on a computer readable medium (e.g., the memory 112) and executed by a processing device (e.g., the processor 110), or a combination thereof that is configured to receive and/or transmit data from/to another computing device. In some example embodiments, the communication interface 114 is at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. In embodiments wherein the apparatus 102 is embodied as a mobile terminal 10, the communication interface 114 may be embodied as or comprise the transmitter 14 and receiver 16 (shown in FIG. 2). The communication interface 114 may be configured to receive and/or transmit data using any protocol that may be used for communications between computing devices. In this regard, the communication interface 114 may be configured to receive and/or transmit data using any protocol that may be used for transmission of data over a wireless network, wireline network, some combination thereof, or the like by which the apparatus 102 and one or more computing devices may be in communication. As an example, the communication interface 114 may be configured to receive and/or otherwise access content (e.g., web page content, streaming media content, and/or the like) over a network from a server or other content source. Additionally or alternatively, the communication interface 114 may be configured to support communications in accordance with any proximity-based protocol including, for example, Wi-Fi, NFC, BlueTooth, WiMAX or the like. The communication interface 114 may additionally be in communication with the memory 112, user interface 116, and/or UI control circuitry 122, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a joystick, a display, a touchscreen display, a microphone, a speaker, and/or other input/output mechanisms. In some embodiments, a display may refer to display on a screen, on a wall, on glasses (e.g., near-eye-display), in the air, etc. In embodiments wherein the apparatus 102 is embodied as a mobile terminal 10, the user interface 116 may be embodied as or comprise the display 28 and keypad 30 (shown in FIG. 2). The user interface 116 may be in communication with the memory 112, communication interface 114, and/or UI control circuitry 122, such as via a bus.

The UI control circuitry 122 may be embodied as various means, such as circuitry, hardware, a computer program product comprising computer readable program instructions stored on a computer readable medium (e.g., the memory 112) and executed by a processing device (e.g., the processor 110), or some combination thereof and, in some embodiments, is embodied as or otherwise controlled by the processor 110. In some example embodiments wherein the UI control circuitry 122 is embodied separately from the processor 110, the UI control circuitry 122 may be in communication with the processor 110. The UI control circuitry 122 may further be in communication with one or more of the memory 112, communication interface 114, or user interface 116, such as via a bus.

The UI control circuitry 122 may be configured to receive user input from a user interface 116, such as a touch display (e.g., touchscreen). The user input or signal may carry positional information indicative of the user input. In this regard, the position may comprise a position of the user input in a two-dimensional space, which may be relative to the surface of the touch display user interface. For example, the position may comprise a coordinate position relative to a two-dimensional coordinate system (e.g., an X and Y axis), such that the position may be determined. Accordingly, the UI control circuitry 122 may determine a position of the user input such as for determining a portion of the display to which the user input correlates.

The touch display may also be configured to enable the detection of a hovering gesture input. A hovering gesture input may comprise a gesture input to the touch display without making physical contact with a surface of the touch display, such as a gesture made in a space some distance above/in front of the surface of the touch display. As an example, the touch display may comprise a capacitive touch display, which may be configured to enable detection of capacitance of a finger or other input object by which a gesture may be made without physically contacting a display surface. As another example, the touch display may be configured to enable detection of a hovering gesture input through use of acoustic wave touch sensor technology, electromagnetic touch sensing technology, near field imaging technology, optical sensing technology, infrared proximity sensing technology, some combination thereof, or the like.

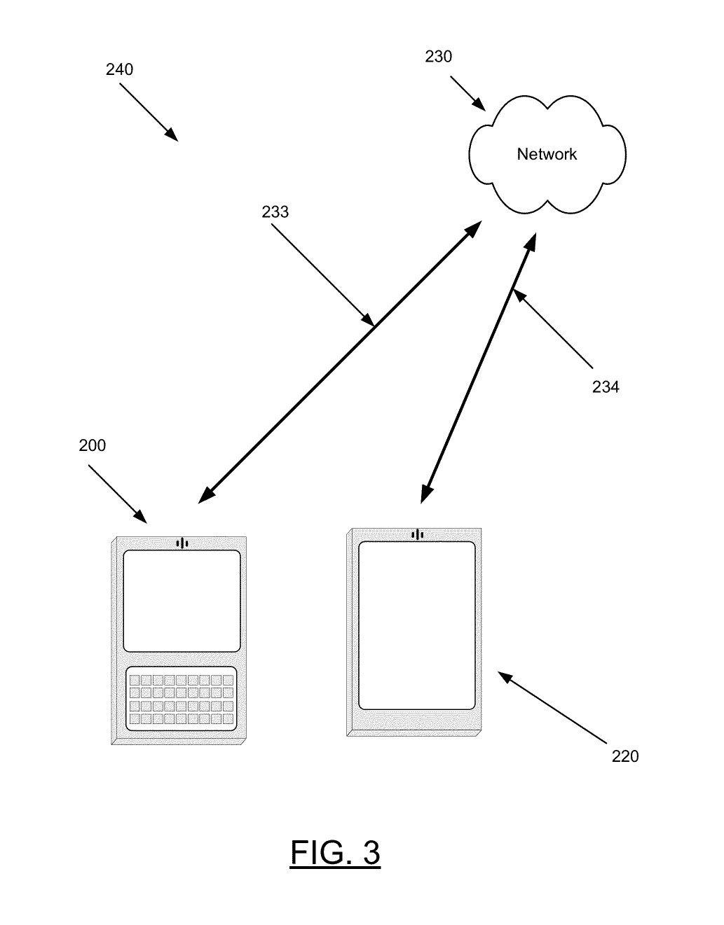

As noted above, the apparatus 102 (shown in FIG. 1) may be configured to perform operations. Indeed, in some embodiments, the apparatus 102 may be configured to enable communication between users of different apparatuses. In some embodiments, the apparatus 102 may be configured to enable a communication session between at least two users. For example, a user of one apparatus may engage in a communication session with another user of a different apparatus. The communication session can occur between any two apparatuses (or even the same apparatus). Along these lines, in some embodiments, the communication session may occur over a network between two remote apparatuses. For example, with reference to FIG. 3, a user (not shown) of a first apparatus 200 may be engaged in a communication session 240 with a user (not shown) of a second apparatus 220. In the example communication session 240, the first apparatus 200 transmits and receives signals 233 to and from a network 230. Similarly, the second apparatus 220 transmits and receives signals 234 to and from the network 230. In such a manner, the first apparatus 200 and the second apparatus 220 may exchange information (e.g., for the communication session 240) through the network 230.

Though the above example embodiment details use of a network to enable a communication session, embodiments of the present invention contemplate other means to enable the communication session (e.g., direct communication between the apparatuses). Along these lines, in some embodiments, the communication session may occur on the same apparatus between two different users.

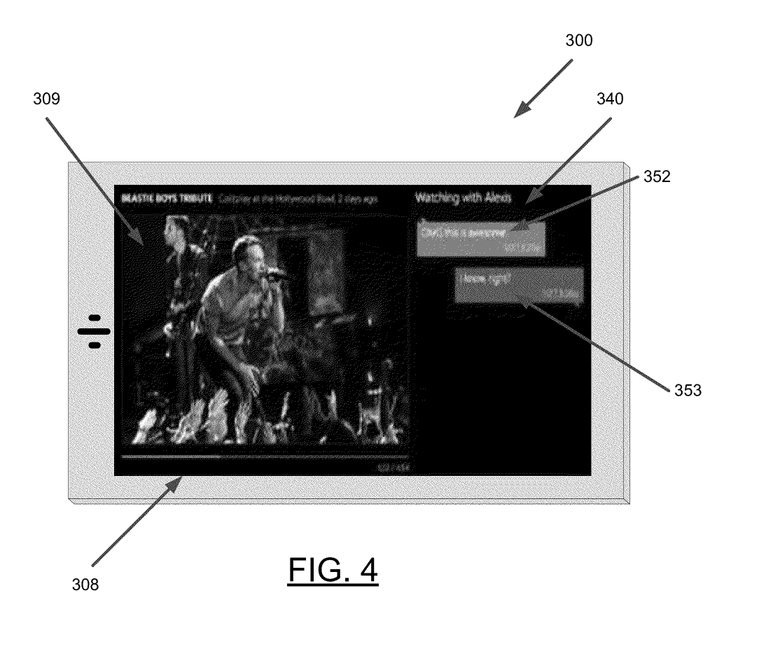

In some embodiments, the communication session may be any type of session in which the users can communicate with each other (e.g., text-based, voice-based, etc.). In some example embodiments, the communication session may involve non-verbal interaction between the users, such as enabling the users to simultaneously watch a video or play a game, among other interactions (e.g., share a photo, etc.). For example, with reference to FIG. 4, a user (not shown) of an apparatus 300 may be engaged in a communication session 340 with a second user, Alexis (not shown). In the depicted embodiment, the apparatus 300 is presenting a video 309 on a screen 308. The same video 309 may also be playing on an apparatus being used by the second user. In addition, the first user and the second user may be engaged in a text-based conversation (e.g., instant messaging). In the depicted embodiment, the second user provided a first comment 352, “OMG this is awesome,” and the first user responded with a second comment 353, “I know, right?” In some example embodiments the interaction between the users may occur in real-time, in the sense that the users are both actively engaged with the communication session at the same time as each other (or two or more are actively engaged at the same time, in the event that the communication session involves more than two users).

During the communication session, two or more users may engage in conversation and/or share an experience. Some embodiments of the present invention seek to enhance that experience by proposing trivia that may be relevant to the communication session. Along these lines, in some embodiments of the present invention, one or more of the users may be prompted with trivia (e.g., additional factual information) concerning the communication session that they can use during the communication session. Along these lines, the proposed trivia can provide one or more of the users interesting information concerning the communication session.

As used herein, in some embodiments, the term “trivia” may refer to details, considerations or pieces of information being proposing to one or more users. In some embodiments, trivia may refer to factual information relevant to a context of a communication session. As used herein, in some embodiments, the term “factual information” may refer to something that is a truth, a reality, and/or has actually occurred. In such a regard, factual information may not be made up or related to concepts that are not factual (e.g., general conversation topics, such as “hi” or “how are you?”).

In some embodiments, the apparatus 300, such as through a processor 110, may be configured to determine at least one trivia candidate for a communication session between at least two users. In some embodiments, the at least one trivia candidate may comprise factual information relevant to a context of the communication session.

As used herein, in some embodiments, the term “context” may refer to information that sheds light and/or helps define/make-up the communication session. For example, in some embodiments, the context of the communication session may information related to at least one of the users of the communication session, the topic of the communication session, or a word used in the communication session.

For example, in the example embodiment illustrated in FIG. 4, the at least one trivia candidate may be based on some aspect of the communication session, such as the video being shared, a topic of the conversation, a common interest of the users, a fact about one of the users, a fact about one of the users' contacts and/or friends, etc. In such a regard, in some embodiments, the at least one trivia candidate may be based on at least one keyword associated with the communication session. In some embodiments, the keyword may be derived from metadata associated with the communication session. Such a keyword may, for example, be derived from the name of the video being shared, a word previously used in the communication session, etc.

In such a regard, in some embodiments, the apparatus 300, such as through the processor 110, may be configured to dynamically determine the context of the communication session. For example, in some embodiments, the context may be determined during the communication session or upon initiation of the communication session. Along these lines, in some embodiments, the context may be determined based on the content of the communication session, the identity of the users, etc. Further, in some embodiments, the apparatus 300, such as through the processor 110, may be configured to dynamically determine at least one trivia candidate based on that dynamically determined context. In such a manner, some embodiments of the present invention provide a dynamic system for determining context of a communication session and determining at least one trivia candidate.

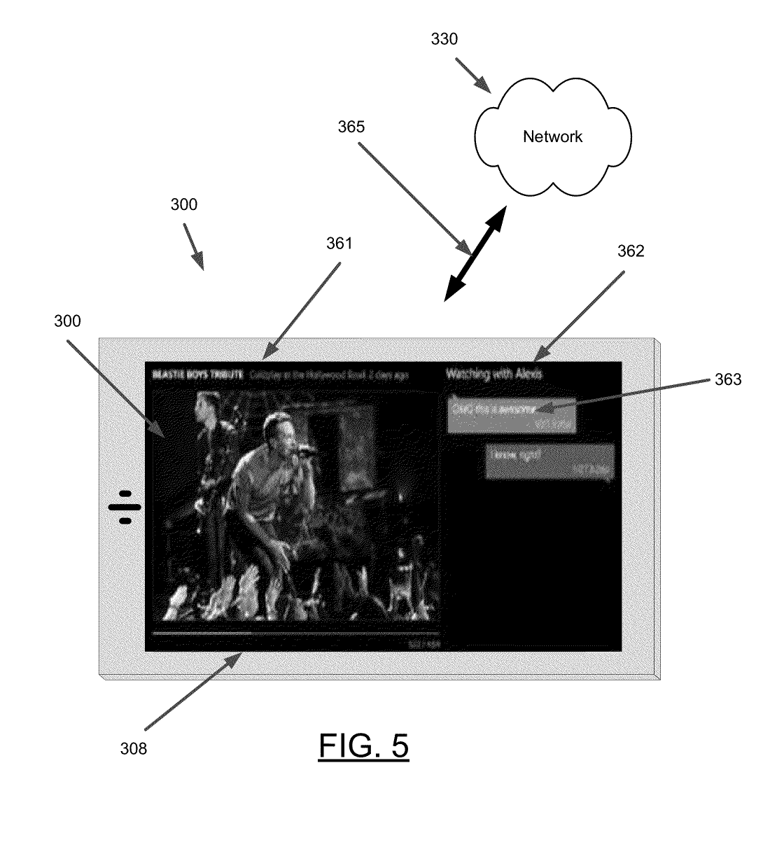

Indeed, in some embodiments, the communication session may comprise any number of different contexts that may be used by the apparatus 300 to determine at least one trivia candidate. For example, with reference to FIG. 5, the communication session 340 may comprise watching a video 309 of a concert performed by Coldplay 361. Additionally, as noted above, the conversation may be occurring between the user and a person named Alexis 362. Indeed, in such a circumstance, the band name of Coldplay 361 or the person Alexis 362 could form a context for which the apparatus 300 may use to determine the at least one trivia candidate. Further, the fact that Alexis finds the video awesome may be another context that could be used for determining at least one trivia candidate. Along these lines, in such an example embodiment, any one of the terms Coldplay, Alexis, or awesome could be used as keywords to determine the at least one trivia candidate.

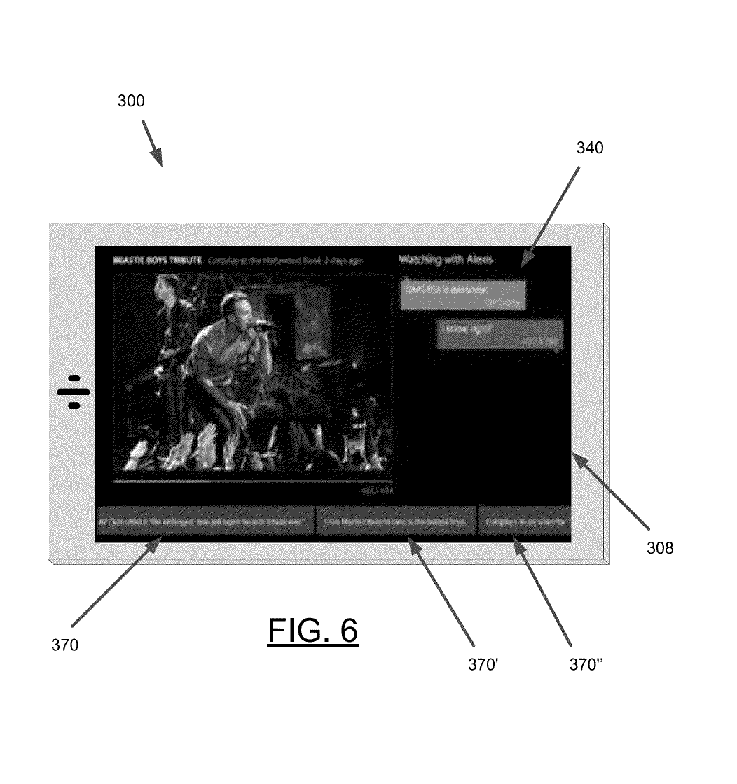

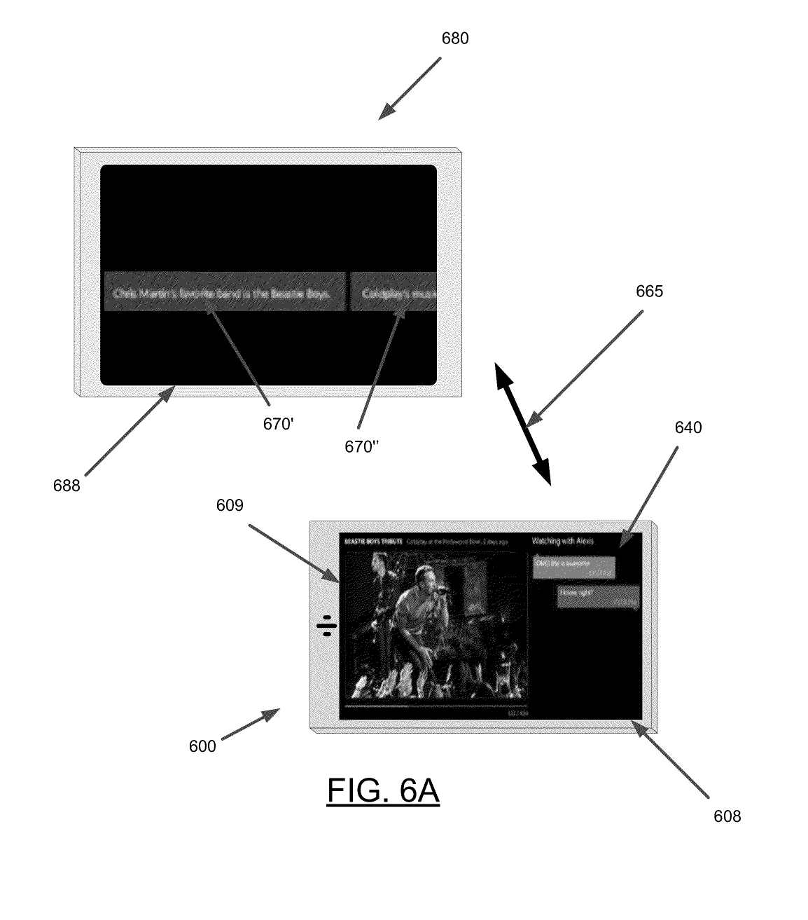

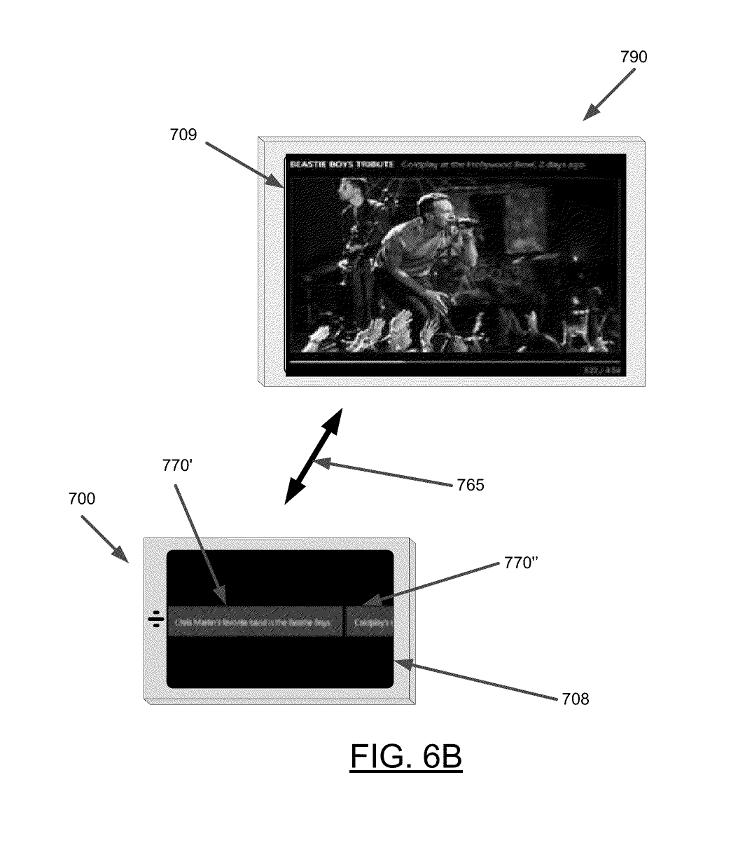

As noted above, the trivia candidate may comprise factual information relevant to a context of the communication session. In such a regard, in some embodiments, the apparatus 300, such as through the processor 110, may be configured to determine the at least one trivia candidate by determining the at least one trivia candidate based on information from a network search (e.g., an internet search). For example, with reference to FIG. 5, the apparatus 300 may perform a search through a network 330, such as through signals 365. The search could be used to determine the at least one trivia candidate, such as from information retrieved from the search related to a context of the communication session. For example, the apparatus 300 may perform an internet search for information related to Coldplay (or even the specific performance being shown in the video 309). In turn, with reference to FIG. 6, the apparatus 300 may determine a trivia candidate 370 of “W Club called it ‘the rockingest, tear-jerkingest, musical tribute ever.’” In such an example, the trivia candidate 370 comprises factual information (e.g., a quote from the W Club) relevant to a context of the communication session (e.g., the performance shown in the shared video 309). Additionally, the apparatus 300 may determine another example trivia candidate 370′ of “Chris Martin's favorite band is the Beastie Boys.” In such an example, Chris Martin, the lead singer of Coldplay, has indicated that the Beastie Boys is his favorite band. As shown in FIG. 5, the video 309 is a performance by Coldplay of a Beastie Boys tribute. In such an example, the trivia candidate 370′ comprises factual information (e.g., Chris Martin's favorite band) relevant to a context of the communication session (e.g., Chris Martin is the lead singer of Coldplay (which is performing in the shared video) and/or the name of the band for which the video is tribute to).

Though the above example describes a network search using the internet, other searches are also contemplated by some embodiments of the present invention (e.g., local memory search, contact search, etc.).

Additionally or alternatively, in some embodiments, the apparatus 300, such as through the processor 110, may be configured to determine the at least one trivia candidate by determining the at least one trivia candidate based on information from a social networking website. For example, the apparatus 300 may perform a search for information on a social networking website related to Alexis (or even a shared friend of Alexis and the first user). In turn, with reference to FIG. 6, the apparatus 300 may determine a trivia candidate 370′ of “Chris Martin's favorite band is the Beastie Boys.” In such an example, Chris Martin (not necessarily the lead singer of Coldplay in this example) may be a shared friend of Alexis and the first user. As shown in FIG. 5, the video 309 is a performance by Coldplay of a Beastie Boys tribute. In such an example, the trivia candidate 370′ comprises factual information (e.g., Chris Martin's favorite band) relevant to a context of the communication session (e.g., a contact of Alexis and/or the name of the band for which the video is related).

In some embodiments, the apparatus 300, such as through the user interface 116, may be configured to cause the at least one trivia candidate to be proposed to at least one of the users. In some embodiments, the apparatus 300, such as through the user interface 116, may be configured to cause the at least one trivia candidate to be presented to at least one of the users, such as on a screen. For example, with reference to FIG. 6, the apparatus 300 may present trivia candidates 370, 370′, and 370″ to the first user, such as on the screen 308. In the depicted embodiment, the apparatus 300 has proposed the trivia candidate 370 of “W Club called it ‘the rockingest, tear-jerkingest, musical tribute ever’” and the trivia candidate 370′ of “Chris Martin's favorite band is the Beastie Boys” for the first user.

Though the above described embodiment depicts the trivia candidates being presented to the first user, in some embodiments, the one or more trivia candidates may also be presented to the second user, such as on the apparatus being used by the second user. Along these lines, in some embodiments, different trivia candidates may be proposed to the second user.

In some embodiments, the apparatus 300 may be configured to cause the at least one trivia candidate to be proposed in different ways (e.g., as a ticker tape, audibly, etc.). Indeed, in some embodiments, the apparatus 300 may be configured to present more than one trivia candidate in a manner in which the trivia candidate scrolls (e.g., appear to move) across the screen. For example, with reference to FIG. 6, the trivia candidate 370″ has partially scrolled off the screen 308 to the right.

In some embodiments, the apparatus 300 may be configured to update the at least one trivia candidate during the communication session. For example, as the context of the communication session changes or evolves the apparatus may determine at least one new trivia candidate based on a new context of the communication session. Moreover, in some embodiments, these new trivia candidates may be presented such that they appear to scroll across the screen as they are determined, providing a “ticker tape” of trivia candidates.

In some embodiments, the apparatus (such as the apparatus 102 of FIG. 1) may be configured to cause the at least one trivia candidate to be proposed on a second apparatus, which may be different than a first apparatus that is conducting the communication session. In some embodiments, the apparatus of the present invention may be embodied as either the first apparatus or the second apparatus (or any apparatus in communication with the first and second apparatus). Along these lines, the trivia candidates may be presented to one or more users of the communication session on a remote device. Indeed, such an embodiment, may provide a number of advantages. On example advantage is that presentation of the at least one trivia candidate may not directly disturb the communication session (e.g., by taking up space on the display showing the communication session). Another example advantage is that the user may not be able to see the display of the second apparatus (e.g., the user is talking on the phone and the apparatus is up next to their ear).

FIG. 6A illustrates an example environment of an apparatus 600 causing performance of a communication session. The communication session includes a text-based conversation 640 and playing a shared video 609. In the depicted embodiment, the apparatus 600 may cause the trivia candidates 670′, 670″ to be presented on a screen 688 of a second apparatus 680 (e.g., a tablet). This can be accomplished, for example, through signals 665 between the first apparatus 600 and the second apparatus 680. In the depicted embodiment, the perspective of the present invention may be, for example, from that of any of the first apparatus 600, second apparatus 680, or any other apparatus or server (not shown) in communication with the first apparatus 600 and the second apparatus 680.

FIG. 6B illustrates another example environment of a communication session of a shared video 709 being played on a television 790. In the depicted embodiment, the second apparatus 700 may cause presentation of the trivia candidates 770′, 770″ on a screen 708. This can be accomplished, for example, through signals 765 between the television 790 and the second apparatus 700. In the depicted embodiment, the perspective of the present invention may be, for example, from that of any of the television 790, second apparatus 700, or any other apparatus or server (not shown) in communication with the television 790 and the second apparatus 700.

In some embodiments, the apparatus 300, such as through the processor 110 and/or user interface 116, may be configured to cause the at least one trivia candidate to be proposed to the at least one user such that the at least one trivia candidate is able to be utilized during the communication session. For example, the at least one trivia candidate may be utilized by a user by being implemented into the communication session. Implementation of the trivia candidate into the communication session may occur in any way such that it becomes part of the communication session. For example, one or more of the users may verbally say at least a portion of the trivia candidate. Alternatively, the trivia candidate can be presented to one or more of the users. Along these same lines, the trivia candidate may be presented within a string of texts that defines at least a portion of the communication session.

For example, in the situation in which the communication session is a voice-based communication session, the apparatus 102 may be configured to cause the at least one trivia candidate to the presented to the user such that the user can say the trivia candidate (or information within the trivia candidate) during the conversation, such as to the other user. In such a regard, the communication session can be enhanced. Likewise, in the situation in which the communication session is a text-based communication session, the apparatus 300 may be configured to cause the at least one trivia candidate to the presented to the user such that the user can type (e.g., input) the trivia candidate (or information within the trivia candidate) during the conversation, such as to be sent to the other user.

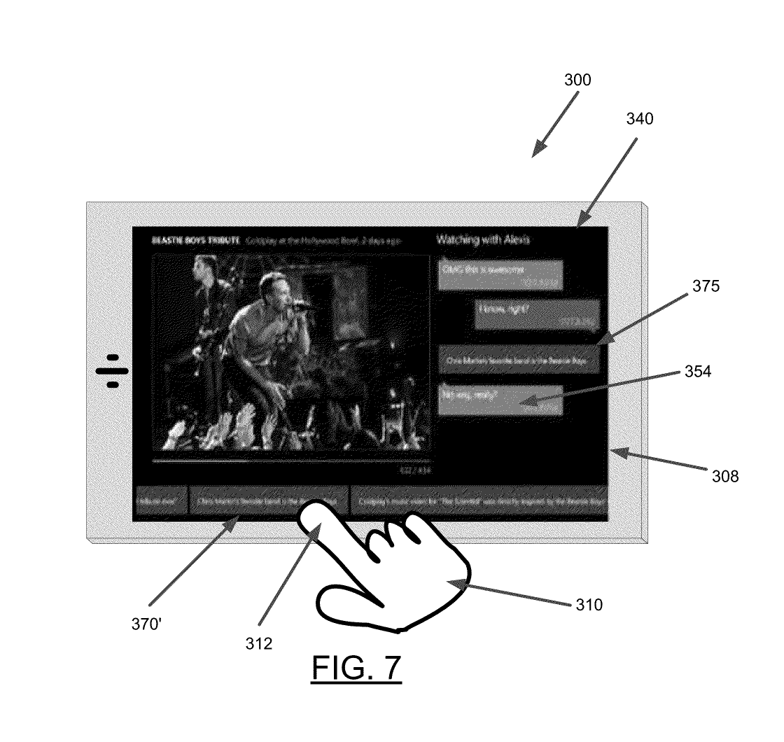

In some embodiments, the apparatus 300, such as through the user interface 116, may be configured to receive an indication of a selection of the at least one trivia candidate by at least one user of the communication session. Additionally, in some embodiments, the apparatus 300, such as through the processor 110 and/or user interface 116, may be configured to cause the at least one trivia candidate to be presented to at least one other user of the communication session in response to receiving the indication of the selection of the at least one trivia candidate. In such a regard, a user can simply provide an input to select one of the trivia candidates and that trivia candidate can be included in the communication session, such as by being presented and/or sent to another user of the communication session. For example, with reference to FIG. 7, the first user 310 may select the trivia candidate 370′ of “Chris Martin's favorite band is the Beastie Boys,” such as with their finger 312. In response to the user 310 selecting the trivia candidate 370′, the apparatus 300 causes presentation of the trivia candidate 370′ within the text-based conversation between the user 310 and the second user, Alexis (e.g., at 375). In such an example, one or more users of the communication session 340 can see the trivia candidate and, perhaps, comment on it. For example, Alexis provides a comment 354 of “No way, really?” In such a manner, the communication session 340 between the user 310 and Alexis is enhanced by the additional factual information of the trivia candidate.

Though, some of the above described embodiments detail presenting the at least one trivia candidate to one or more other users after the first users selects the trivia candidate, some embodiments of the present invention may be configured to automatically present the at least one trivia candidate to one or more of the other users. For example, with reference to FIG. 7, in some embodiments, the trivia candidate 370′ of “Chris Martins' favorite band is the Beastie Boys” may be automatically presented within the text-based conversation (e.g., without the first user 310 selecting it).

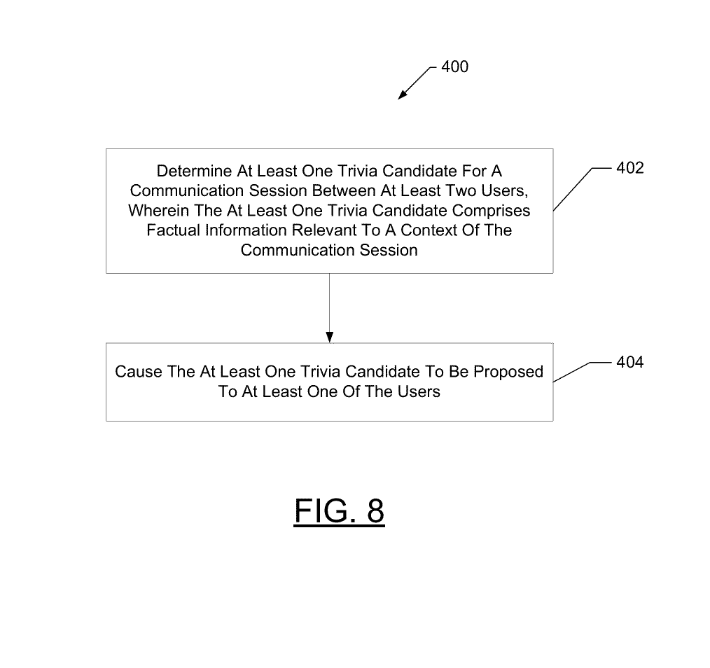

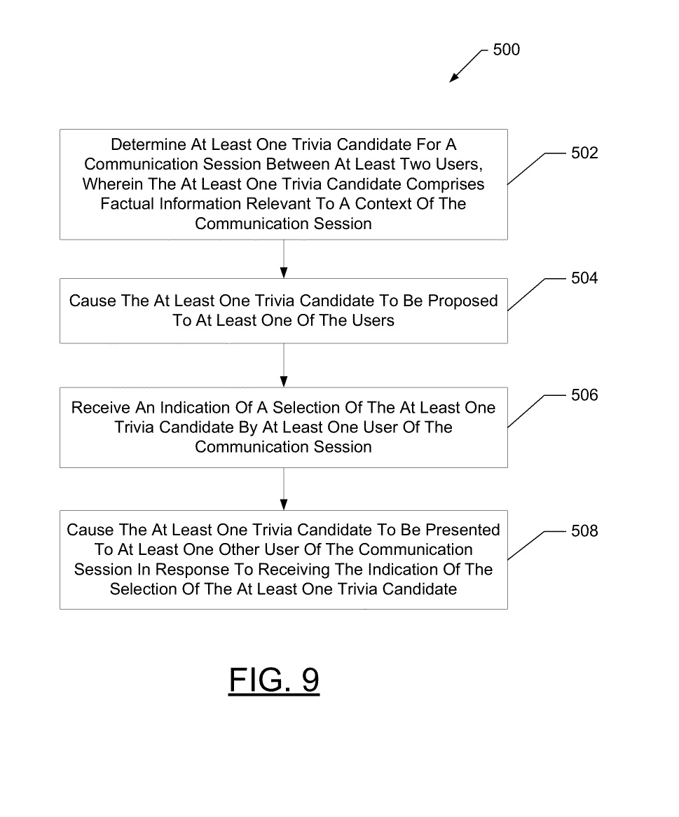

Embodiments of the present invention provide methods, apparatus and computer program products for proposing trivia during a communication session. Various examples of the operations performed in accordance with embodiments of the present invention will now be provided with reference to FIGS. 8-9.

FIG. 8 illustrates a flowchart according to an example method for proposing trivia during a communication session according to an example embodiment 400. The operations illustrated in and described with respect to FIG. 8 may, for example, be performed by, with the assistance of, and/or under the control of one or more of the processor 110, memory 112, communication interface 114, user interface 116, or UI control circuitry 122 (shown in FIG. 1). Operation 402 may comprise determining at least one trivia candidate for a communication session between at least two users, wherein the at least one trivia candidate comprises factual information relevant to a context of the communication session. The processor 110 may, for example, provide means for performing operation 402. Operation 404 may comprise causing the at least one trivia candidate to be proposed to at least one of the users. The processor 110, user interface 116, and/or UI control circuitry 122 may, for example, provide means for performing operation 404.

FIG. 9 illustrates a flowchart according to another example method for proposing trivia during a communication session according to an example embodiment 500. The operations illustrated in and described with respect to FIG. 9 may, for example, be performed by, with the assistance of, and/or under the control of one or more of the processor 110, memory 112, communication interface 114, user interface 116, or UI control circuitry 122 (shown in FIG. 1). Operation 502 may comprise determining at least one trivia candidate for a communication session between at least two users, wherein the at least one trivia candidate comprises factual information relevant to a context of the communication session. The processor 110 may, for example, provide means for performing operation 502. Operation 504 may comprise causing the at least one trivia candidate to be proposed to at least one of the users. The processor 110, user interface 116, and/or UI control circuitry 122 may, for example, provide means for performing operation 504. Operation 506 may comprise receiving an indication of a selection of the at least one trivia candidate by at least one user of the communication session. The user interface 116 and/or UI control circuitry 122 may, for example, provide means for performing operation 506. Operation 508 may comprise causing the at least one trivia candidate to be presented to at least one other user of the communication session in response to receiving the indication of the selection of the at least one trivia candidate. The processor 110, user interface 116, and/or UI control circuitry 122 may, for example, provide means for performing operation 508.

FIGS. 8-9 each illustrate a flowchart of a system, method, and computer program product according to an example embodiment. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of a mobile terminal, server, or other computing device (for example, in the memory 112) and executed by a processor in the computing device (for example, by the processor 110). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 102) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 102) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowcharts support combinations of means for performing the specified functions. It will also be understood that one or more blocks of the flowcharts, and combinations of blocks in the flowcharts, may be implemented by special purpose hardware-based computer systems which perform the specified functions, or combinations of special purpose hardware and computer program product(s).

The above described functions may be carried out in many ways. For example, any suitable means for carrying out each of the functions described above may be employed to carry out embodiments of the invention. In one embodiment, a suitably configured processor (for example, the processor 110) may provide all or a portion of the elements. In another embodiment, all or a portion of the elements may be configured by and operate under control of a computer program product. The computer program product for performing the methods of an example embodiment of the invention includes a computer-readable storage medium (for example, the memory 112), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A method comprising:
determining, by a processor, at least one trivia candidate for a communication session between at least two users, wherein the at least one trivia candidate comprises factual information relevant to a context of the communication session; and
causing the at least one trivia candidate to be proposed to at least one of the users.

2. The method according to claim 1, wherein determining the at least one trivia candidate comprises determining the at least one trivia candidate based on at least one keyword associated with the communication session.

3. The method according to claim 2, wherein the at least one keyword has been previously used by at least one of the users in the communication session.

4. The method according to claim 1, wherein determining the at least one trivia candidate comprises determining the at least one trivia candidate based on information from a social networking website.

5. The method according to claim 1, wherein determining the at least one trivia candidate comprises determining the at least one trivia candidate based on information from a network search.

6. The method according to claim 1, wherein causing the at least one trivia candidate to be proposed to at least one of the users comprises causing the at least one trivia candidate to be proposed such that the at least one trivia candidate is able to be utilized during the communication session.

7. The method according to claim 1 further comprising:
receiving an indication of a selection of the at least one trivia candidate by at least one user of the communication session; and
causing the at least one trivia candidate to be presented to at least one other user of the communication session in response to receiving the indication of the selection of the at least one trivia candidate.

8. The method according to claim 7, wherein the communication session comprises a text-based communication session.

9. The method according to claim 1, wherein causing the at least one trivia candidate to be proposed to at least one of the users comprises causing the at least one trivia candidate to be presented to the at least one user.

10. The method according to claim 9, wherein the communication session comprises a voice-based communication session.

11. An apparatus comprising a processor and a memory including computer program code, the memory and the computer program code configured to, with the processor, cause the apparatus to:
determine at least one trivia candidate for a communication session between at least two users, wherein the at least one trivia candidate comprises factual information relevant to a context of the communication session; and
cause the at least one trivia candidate to be proposed to at least one of the users.

12. The apparatus of claim 11, wherein the memory and the computer program code are further configured to, with the processor, cause the apparatus to determine the at least one trivia candidate by determining the at least one trivia candidate based on at least one keyword associated with the communication session.

13. The apparatus of claim 12, wherein the at least one keyword has been previously used by at least one of the users in the communication session.

14. The apparatus of claim 11, wherein the memory and the computer program code are further configured to, with the processor, cause the apparatus to determine the at least one trivia candidate by determining the at least one trivia candidate based on information from a social networking website.

15. The apparatus of claim 11, wherein the memory and the computer program code are further configured to, with the processor, cause the apparatus to determine the at least one trivia candidate by determining the at least one trivia candidate based on information from a network search.

16. The apparatus of claim 11, wherein the memory and the computer program code are further configured to, with the processor, cause the apparatus to cause the at least one trivia candidate to be proposed to at least one of the users by causing the at least one trivia candidate to be proposed such that the at least one trivia candidate is able to be utilized during the communication session.

17. The apparatus of claim 11, wherein the memory and the computer program code are further configured to, with the processor, cause the apparatus to:
receive an indication of a selection of the at least one trivia candidate by at least one user of the communication session; and
cause the at least one trivia candidate to be presented to at least one other user of the communication session in response to receiving the indication of the selection of the at least one trivia candidate.

18. The apparatus of claim 11, wherein the memory and the computer program code are further configured to, with the processor, cause the apparatus to cause the at least one trivia candidate to be proposed to at least one of the users by causing the at least one trivia candidate to be presented to the at least one user.

19. Computer program product comprising a non-transitory computer readable storage medium having program code portions stored thereon, the program code portions being configured when said program product is run on a computer or network device, to:
determine at least one trivia candidate for a communication session between at least two users, wherein the at least one trivia candidate comprises factual information relevant to a context of the communication session; and
cause the at least one trivia candidate to be proposed to at least one of the users.

20. The computer program product of claim 19, wherein the program code portions are further configured, when said program product is run on a computer or network device, to determine the at least one trivia candidate by determining the at least one trivia candidate based on at least one keyword associated with the communication session.
